(19) United States
(12) Patent Application Publication
(10) Pub. No.: US 2015/0310531 A1
(43) Pub. Date: Oct. 29, 2015

(54) Electronic Shopping Assembly

(71) Applicant: Terrance Fountain, Merriville, IN (US)

(72) Inventor: Terrance Fountain, Merriville, IN (US)

(21) Appl. No.: 14/259,675

(22) Filed: Apr. 23, 2014

(51) Int. Cl. G06Q 30/06; G06F 1/16

(52) U.S. Cl. CPC G06Q 30/0633; G06Q 30/0639; G06F 1/1626

(57) ABSTRACT

A electronic shopping assembly includes a housing that may be carried by a user. A processor is coupled to the housing. An electronic memory is coupled to the housing and the processor. A transceiver is coupled to the housing and the processor. The transceiver is in communication with an external electronic device in a store and a cellular phone network. A touch screen display is coupled to the housing and the processor. An actuator is coupled to the housing and the processor. A scanner is coupled to the housing and the processor. The scanner scans a bar code on an item on the shopping list. The item is removed from the shopping list and a cost of the item is stored in the electronic memory. A GPS is coupled to the housing and the processor. The GPS directs the user to a location of an item on the shopping list.

### BACKGROUND OF THE DISCLOSURE

### Field of the Disclosure

The disclosure relates to electronic shopping devices and more particularly pertains to a new electronic shopping device for storing a shopping list and updating the list as items on the list are purchased.

### SUMMARY OF THE DISCLOSURE

An embodiment of the disclosure meets the needs presented above by generally comprising a housing that may be carried by a user. A processor is coupled to the housing. An electronic memory is coupled to the housing. The electronic memory is operationally coupled to the processor. A transceiver is coupled to the housing. The transceiver is operationally coupled to the processor. The transceiver is in communication with an external electronic device in a store. The transceiver is in communication with a cellular phone network. A display is coupled to the housing. The display is operationally coupled to the processor. The user touches the display to enter the shopping list into the electronic memory. An actuator is coupled to the housing. The actuator is operationally coupled to the processor so the actuator selectively actuates the processor. A scanner is coupled to the housing. The scanner is operationally coupled to the processor. The scanner scans a bar code on an item on the shopping list. The item is removed from the shopping list and a cost of the item is stored in the electronic memory. A GPS is coupled to the housing. The GPS is operationally coupled to the processor. The GPS directs the user to a location of an item on the shopping list.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a perspective view of a electronic shopping assembly according to an embodiment of the disclosure.

FIG. 2 is a bottom view of an embodiment of the disclosure.

FIG. 3 is a front view of an embodiment of the disclosure.

FIG. 4 is a top view of an embodiment of the disclosure.

FIG. 5 is a schematic view of an embodiment of the disclosure.

### DESCRIPTION OF THE PREFERRED EMBODIMENT

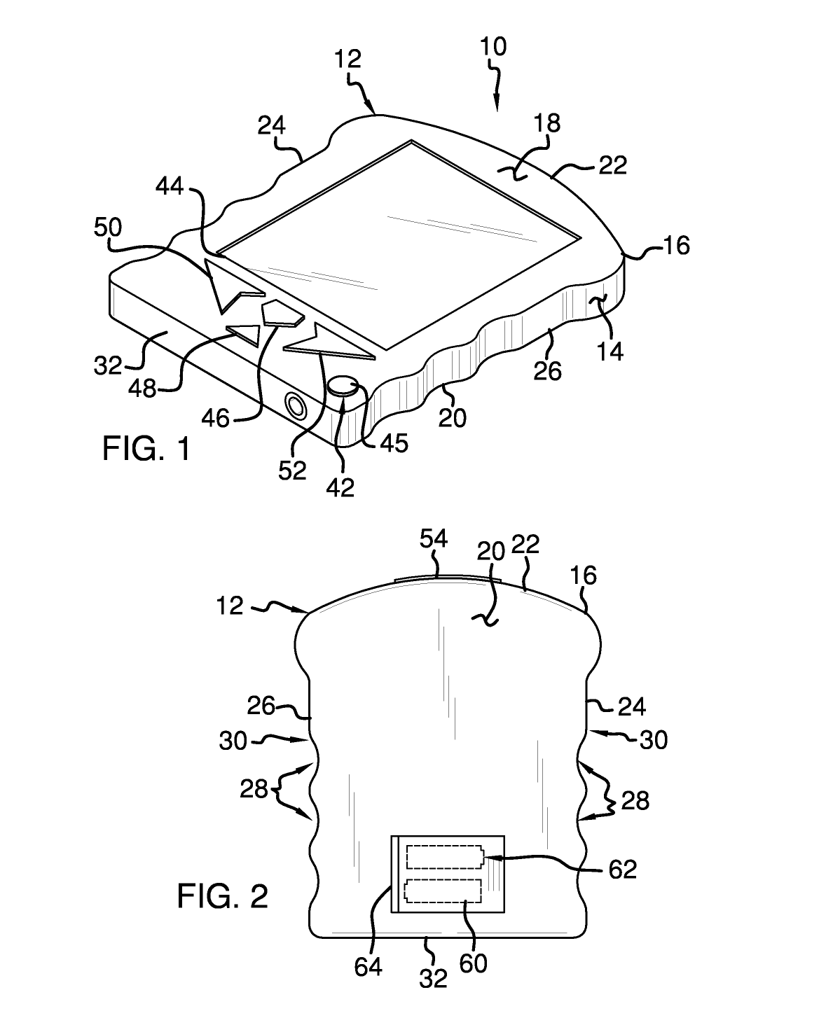

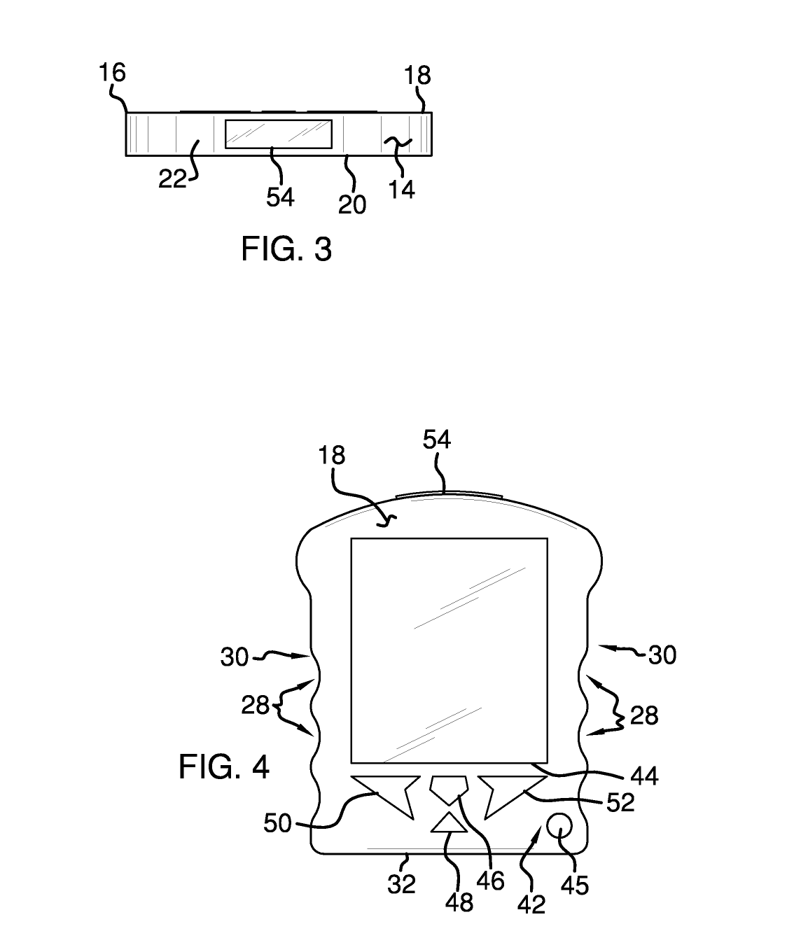

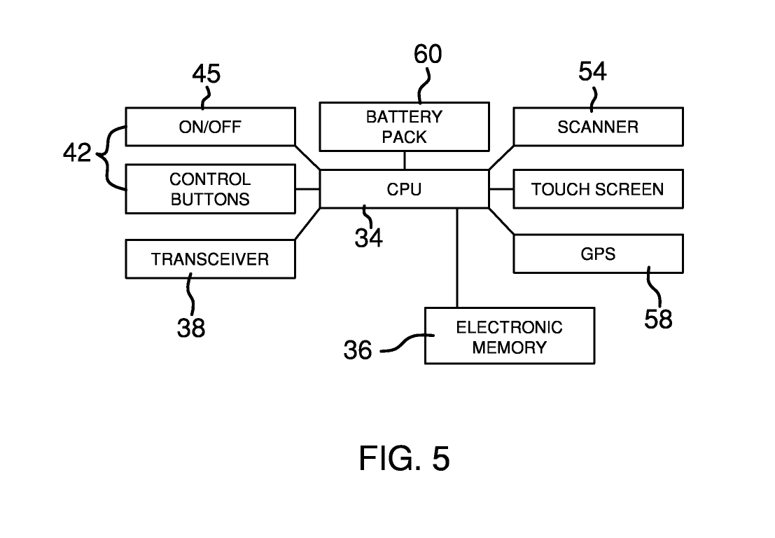

With reference now to the drawings, and in particular to FIGS. 1 through 5 thereof, a new electronic shopping device embodying the principles and concepts of an embodiment of the disclosure and generally designated by the reference numeral 10 will be described.

As best illustrated in FIGS. 1 through 5, the electronic shopping assembly 10 generally comprises a housing 12. An exterior surface 14 of an outer wall 16 of the housing 12 extends between each of a top surface 18 and a bottom surface 20 of the outer wall 16 of the housing 12. A front side 22 of the exterior surface 14 of the outer wall 16 of the housing 12 is convexly curvilinear between each of a first 24 and a second 26 lateral side of the exterior surface 14 of the outer wall 16 of the housing 12. Each of the first 24 and second 26 lateral sides of the exterior surface 14 of the outer wall 16 of the housing 12 curves outwardly proximate the front side 22 of the exterior surface 14 of the outer wall 16 of the housing 12.

The first 24 and lateral 26 sides of the exterior surface 14 of the outer wall 16 of the housing 12 each forms a series of undulating curves 28. The series of undulating curves 28 is distributed between a middle 30 of the exterior surface 14 of the outer wall 16 of the housing 12 and a back side 32 of the exterior surface 14 of the outer wall 16 of the housing 12. The housing 12 is carried by a user. The series of undulating curves 28 may be gripped by the user.

A processor 34 is coupled to the housing 12. The processor 34 may be an electronic processor of any conventional design. An electronic memory 36 is coupled to the housing 12. The electronic memory 36 is electrically coupled to the processor 34. The electronic memory 36 may be RAM memory of any conventional design.

A transceiver 38 is coupled to the housing 12. The transceiver 38 is electrically coupled to the processor 34. Additionally, the transceiver 38 is in electromagnetic communication with an external electronic device in a store. The external electronic device in the store may be the store's inventory computer.

The transceiver 38 is in electromagnetic communication with a cellular phone network. The transceiver 38 transmits and receives text messages. Moreover, the transceiver 38 may be an RF transceiver of any conventional design. The transceiver 38 may utilize a Wireless Personal Access Network signal.

A display 40 is coupled to the top surface 18 of the outer wall 16 of the housing 12. The display 40 is electrically coupled to the processor 34. Continuing, the display 40 may be a touch screen display of any conventional design. The user touches the display 40 to enter information pertaining to a shopping list into the electronic memory 36. Additionally, the user touches the display 40 to compose the text messages.

An actuator 42 is coupled to the top surface 18 of the outer wall 16 of the housing 12. The actuator 42 is positioned between a bottom edge 44 of the display 40 and the back side 32 of the exterior surface 14 of the outer wall 16 of the housing 12. The actuator 42 is electrically coupled to the processor 34. Moreover, the actuator 42 is one of a plurality of the actuators 42. An “enter” one of the plurality of actuators 45 enters information into the processor 34. Each of an “up” one 46, a “down” one 48, a “left” one 50 and a “right” one 52 of the plurality of actuators moves a cursor in the display 40 in a corresponding direction.

A scanner 54 is coupled to the front side 22 of the exterior surface 14 of the outer wall 16 of the housing 12. The scanner 54 is electrically coupled to the processor 34. The scanner 54 scans a bar code on an item on the shopping list so the item is removed from the shopping list. A cost of the item is stored in the electronic memory 36. The scanner 54 may be an infrared scanner of any conventional design.

The user enters a desired budget constraint into the electronic memory 36. The processor 34 compiles a running total of the cost of the items scanned into the electronic memory 36. A coupon may be scanned into the electronic memory 36. The processor 34 deducts the value of the coupon from the cost of the item on the shopping list that is scanned into the electronic memory 36. The electronic memory 36 allows the user to keep a real time total of how much money has been spent in relation to the specified budget constraint.

A GPS 58 is coupled to the housing 12. The GPS 58 is electrically coupled to the processor 32. The GPS 58 directs the user to a location of an item on the shopping list if the user cannot find the item on the shopping list. Moreover, the GPS 58 may be a GPS 58 of any conventional design.

A power supply 60 is coupled to the housing 12. The power supply 60 is electrically coupled to the processor 32. Moreover, the power supply 60 comprises at least one battery 62. A battery cover 64 is removably coupled to the bottom surface 20 of the outer wall 16 of the housing 12. The battery 62 is removably positioned beneath the battery cover 64. The “enter” actuator 45 is held down for a duration of time to actuate and de-actuate the power supply 60.

In use, the user enters the shopping list and the budget constraints into the electronic memory 36 through the display 40. The user scans any coupons the user wishes to utilize. The user physically enters a desired store or retail environment. If the store provides wireless access to the store's inventory computer, the transceiver 36 communicates the shopping list to the store's inventory computer. Additionally, the transceiver 36 receives information pertaining to discounts or other special pricing from the store's inventory computer. The GPS 58 directs the user to any item on the shopping list if the user cannot find the item. The user continues shopping until all of the items on the shopping list have been obtained, or until the user reaches the budget constraint.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded.

A reference to an element by the indefinite article “a” does not exclude the possibility that more than one of the element is present, unless the context clearly requires that there be only one of the elements.

1. An electronic shopping assembly for storing a shopping list and updating the list as items on the list are purchased, said assembly comprising:
a housing, said housing being configured for being carried by a user;
a processor coupled to said housing;
an electronic memory coupled to said housing, said electronic memory being operationally coupled to said processor;
a transceiver coupled to said housing, said transceiver being operationally coupled to said processor, said transceiver being in communication with an external electronic device in a store, said transceiver being in communication with a cellular phone network;
a display coupled to said housing, said display being operationally coupled to said processor, the user touching said display to enter the shopping list into said electronic memory;
an actuator coupled to said housing, said actuator being operationally coupled to said processor such that said actuator selectively actuates said processor;
a scanner coupled to said housing, said scanner being operationally coupled to said processor, said scanner scanning a bar code on an item on the shopping list such that the item is removed from the shopping list and a cost of the item is stored in said electronic memory; and
a global positioning system coupled to said housing, said global positioning system being operationally coupled to said processor, said global positioning system directing the user to a location of an item on the shopping list.

2. The assembly according to claim 1, wherein said housing having an exterior surface of an outer wall of said housing extending between each of a top surface and a bottom surface of said outer wall of said housing.

3. The assembly according to claim 1, wherein said electronic memory being electrically coupled to said processor.

4. The assembly according to claim 1, wherein said transceiver being electrically coupled to said processor.

5. The assembly according to claim 1, wherein said transceiver being in electromagnetic communication with the external electronic device, said transceiver being in electromagnetic communication with the cellular phone network.

6. The assembly according to claim 1, wherein said display being coupled to a top surface of an outer wall of said housing.

7. The assembly according to claim 1, wherein said display being electrically coupled to said processor.

8. The assembly according to claim 1, wherein said actuator being coupled to a top surface of an outer wall of said housing such that said actuator is positioned between a bottom edge of said display and a back side of an exterior surface of said outer wall of said housing.

9. The assembly according to claim 1, wherein said actuator each being electrically coupled to said processor.

10. The assembly according to claim 1, wherein said actuator being one of a plurality of said actuators, each of said plurality of actuators actuating an associated one of a plurality of functions of said processor.

11. The assembly according to claim 1, wherein said scanner being coupled to a front side of an exterior surface of an outer wall of said housing, said scanner being electrically coupled to said processor.

12. The assembly according to claim 1, wherein said global positioning system being electrically coupled to said processor.

13. The assembly according to claim 1, wherein a power supply coupled to said housing.

14. The assembly according to claim 13, wherein said power supply being electrically coupled to said processor.

15. The assembly according to claim 14, wherein said power supply comprising at least one battery.

16. An electronic shopping assembly for storing a shopping list and updating the list as items on the list are purchased, said assembly comprising:
a housing having an exterior surface of an outer wall of said housing extending between each of a top surface and a bottom surface of said outer wall of said housing, said housing being configured for being carried by a user;
a processor coupled to said housing;
an electronic memory coupled to said housing, said electronic memory being electrically coupled to said processor;
a transceiver coupled to said housing, said transceiver being electrically coupled to said processor, said transceiver being in electromagnetic communication with an external electronic device in a store, said transceiver being in electromagnetic communication with a cellular phone network;
a display coupled to said top surface of said outer wall of said housing, said display being electrically coupled to said processor, the user touching said display to enter the shopping list into said electronic memory;
an actuator coupled to said top surface of said outer wall of said housing such that said actuator is positioned between a bottom edge of said display and a back side of said exterior surface of said outer wall of said housing, said actuator being electrically coupled to said processor, said actuator being one of a plurality of said actuators, each of said plurality of actuators actuating an associated one of a plurality of functions of said processor;
a scanner coupled to a front side of said exterior surface of said outer wall of said housing, said scanner being electrically coupled to said processor, said scanner scanning a bar code on an item on the shopping list such that the item is removed from the shopping list and a cost of the item is stored in said electronic memory;
a global positioning system coupled to said housing, said global positioning system being electrically coupled to said processor, said global positioning system directing the user to a location of an item on the shopping list; and
a power supply coupled to said housing, said power supply being electrically coupled to said processor, said power supply comprising at least one battery.
